(19) United States
(12) Patent Application Publication
(10) Pub. No.: US 2002/0005775 A1
(43) Pub. Date: Jan. 17, 2002

(54) Method of supplying customers of a self-service market with product-specific information

(76) Inventors: Horst Sonnendorfer, Puchheim (DE); Franz Wieth, Puchheim (DE)

Correspondence Address: BROWDY AND NEIMARK, P.L.L.C., 624 Ninth Street, N.W., Washington, DC, 20001, US

(21) Appl. No.: 09/829,419

(22) Filed: Apr. 10, 2001

(30) Foreign Application Priority Data
Apr. 10, 2000 (DE) 100 17 166.4

(51) Int. Cl. H04Q 1/00

(52) U.S. Cl. 340/5.91

(57) ABSTRACT

For supplying customers of a self-service market with product-specific information a plurality of items of product-specific information including identification codes of the electronic shelf labels provided at the corresponding products are communicated by emitter means in the entrance area of the self-service market to the detector/emitter means of the shopping cart pushed by the customer and stored therein. On the shopping cart being pushed into the zone of the electronic shelf labels, whose identification code is assigned a stored product-specific information, this product-specific information from the emitter/detector unit of the corresponding electronic shelf labels is activated in the corresponding detector/emitter means of the shopping cart pushed into the zone of the electronic shelf labels and informed to the customer by means of its information means.

During display of product-specific information by means of the information means of the customer shopping cart, an alerting means provided directly at or near to the corresponding product, or in the vicinity thereof, and outputting a visual and/or audible alert, is activated.

### FIELD OF THE INVENTION

The invention relates to a method of supplying customers of a self-service market with product-specific information.

### BACKGROUND OF THE INVENTION

Described in U.S. Pat. No. 5,406,271 is one such method as well as means for its implementation. This system provides transceiver units decentralized in each department or product group of a self-service store. Provided on the shopping cart of the self-service store are transceiver units each including an audible information means in the form of a loudspeaker and/or an visual information means, for example, in the form of a display. Communicating the information and data between the decentralized transceiver units and customer shopping cart transceiver units is wireless, for example, by radio, infrared communication and the like.

Accommodated in the self-service store or the departments thereof are groups of products and thus the transceiver units provided there need to be spaced away from each other, for infrared communication, for example, so that there is no crosstalk between the infrared communication beams. When information pertinent to a particular product is communicated to the customer via the information means on the shopping cart it is often a problem for the customer to quickly relate the information to the product at any one time.

For product identification in self-service stores or markets electronic shelf labels (ESL) are often provided which generally enable the price indication to be made and changed at a centralized location with no appreciable time and labor.

### SUMMARY OF THE INVENTION

It is the objective of the invention to supply customers, pushing a shopping cart in a self-service market, with information as to one or more products of a product group, so-called product-specific information and, where necessary, to simultaneously alert the customer to a product as advertised thereby. It is furthermore intended to permit registration of a correctly communicated item of product-specific information.

In accordance with the invention this objective is achieved by the features of claim 1. Advantageous aspects of the invention read from the claims relating back directly or indirectly to claim 1.

The self-service markets relevant to the invention are understood to be those provided with at least one emitting means supplied with data and information from a central data processing means located only in the entrance area, a large number of shopping carts including detector/emitter means each including an information means and ESLs each including an emitter/detector unit in the products on sale. Furthermore, the communication between the various means is preferably wireless, for example, via radio communication, infrared communication, and the like.

In accordance with the invention it is only in the entrance area of a self-service market that a plurality of items of product-specific information including identification codes of the ESLs provided at the corresponding products are communicated to the detector/emitter means of the shopping carts pushed by the customers and stored therein. When a customer with his shopping cart, in passing through the self-service market, enters the zone of an ESL whose identification code is related to an item of product-specific information stored there, this specific product-specific information is activated by means of this identification code from the emitter/detector unit of this ESL in the detector/emitter means of the shopping cart concerned. Information advertising a specific product is communicated to the customer by means of the information means of the shopping cart concerned, for example, in the form of a display. Where necessary, it may also be provided for to solely or additionally beep alert the customer to the activated product-specific information.

Unlike the prior art method requiring numerous emitter/detector means to be provided decentralized throughout the departments or product groups of a self-service market, it is now advantageously possible in accordance with the invention to provide at least one emitting means only in the entrance area of the self-service market.

Whilst displaying the product-specific information by means of the information means on the shopping cart it may be of advantage and expedient in one aspect of the invention to alert the customer visually, and where necessary audibly, to the advertised product by means of an alerting means located directly at the product or in any case very near thereto. For example, the activated alerting means may produce flashing of the ESL provided on the advertised product or in the immediate vicinity thereof, it being just as possible to also light up the corresponding ESL for a specific period.

Simultaneously with activation of the detector/emitter means on the shopping cart the alerting means may be activated by the emitter/detector unit of the corresponding ESL or also by the activated detector/emitter means of the shopping cart. The alerting means may also be integrated for example, in the ESL.

Thus, the customer now receives not only information specific to a certain product but also an alert to the particular product visually and/or where necessary also audibly, facilitating locating the product in a plurality of similar products in thus eliminating the nuisance of searching for the particular product.

Furthermore, it is now possible to advantage that a visual and/or audible indication by means of the information means on the customer shopping cart is registered in the detector/emitter means thereof. However, it is also possible that correct indication of the product-specific information is confirmed by the detector/emitter means of the shopping cart relative to the emitter/detector unit of the ESL assigned to the corresponding product before then being registered in this ESL. These registrations then serve simultaneously as an acknowledgement of successful communication of a product-specific information every time.

These acknowledgements as stored in the shopping cart detector/emitter means and/or in the emitter/detector unit of the corresponding ESLs enable both the operator of the self-service market and producers to establish not only how often the product has been advertised but also how often an alert was made thereto visually and/or audibly.

Self-service markets often offer customer service cards in attempting to bind customers to the self-service market to a certain extent by conceeding a price reduction on all or specific group of products or, for example, by subsequently crediting or refunding a certain amount once a certain sum is attained, perhaps, in a predefined period.

It is in such a customer service card that, for example, the cash desk is able to record the products purchased by the customer. By comparing the products purchased by the service card holder over a specific period it is then relatively easy to establish a so-called individual customer profile and assign it to the service card holder. By seeing what is usually purchased, a distinction can then be made, for example, between male and female singles and these in turn from customers having one or more children.

To save communicating information to service card holders relative to products for which the particular customer probably has no use, due to his customer profile existing in the self-service market, these customers are communicated only product-specific information matching their individual customer profile and stored in the detector/emitter means of the shopping cart as soon as they are in the entrance area of the self-service market and have been identified by their customer service card.

For example, a single is not communicated any information relative to, for example, baby food, children's clothing, playthings and the like. Customer service card holders are thus spared receiving information in which they are not interested, or indeed would even prove to be a nuisance, as can now be assessed by the market operator with high probability.

To advantage, it is now possible in accordance with the invention, before the customer leaves the self-service market, for the cash desk to record the products purchased and communicate them to central data processing where they are analyzed as to the individual customer profile. As soon as deviations from the customer profile as hitherto recorded are found, the customer profile can be correspondingly changed, supplemented and thus updated with no appreciable hassle.

### BRIEF DESCRIPTION OF THE DRAWINGS

The invention will now be detained by way of the drawings in which:

FIG. 1 is a diagrammatic illustration of an entrance area of a self-service market and a shopping cart, likewise indicated diagrammatically, and

FIG. 2 is a diagrammatic illustration of the same shopping cart located before a product group, likewise indicated diagrammatically.

### DETAILED DESCRIPTION

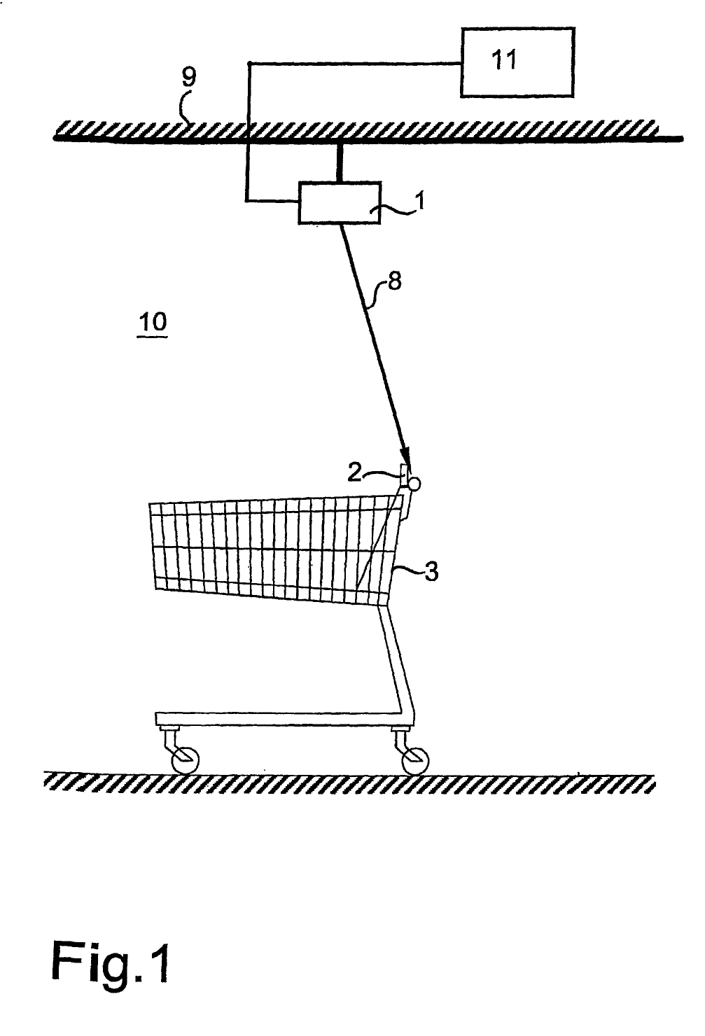

Referring now to FIG. 1 there is illustrated diagrammatically at least one emitter means 1 provided only in the entrance area 10 of a self-service market (not shown), mounted, for example, on a ceiling or in a false ceiling 9 thereof which is supplied with data and information from a central data processing means 11.

Located under the emitter means 1 is a shopping cart 3, on the pushbar of which a detector/emitter means 2 including an information means (not shown) is provided as indicated encircled which may be, for example, a display or some other suitable means of visual indication. As an alternative or in addition thereto a loudspeaker (not shown) of the detector/emitter means may be assigned.

The bold arrow 8 represents a communication beam from the emitter means 1 arranged in the entrance area to the detector/emitter means 2 of a shopping cart 3 located in this area, this communication being wireless, for example, via a suitable modulated infrared beam, although, of course, it is just as possible to provide this communication by electromagnetic waves.

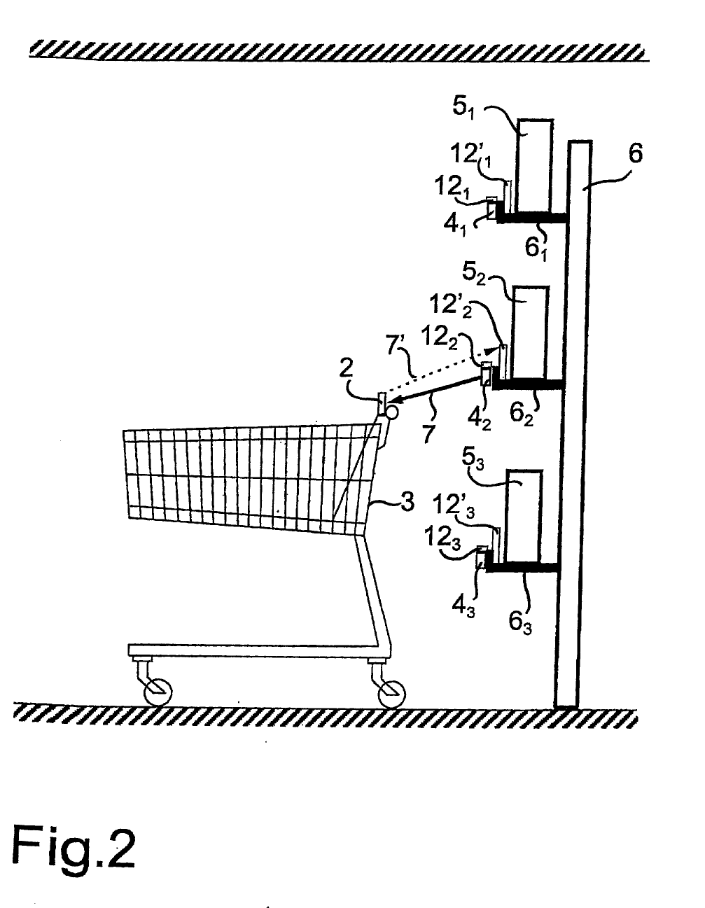

Referring now to FIG. 2 there is illustrated diagrammatically the shopping cart 3 pushed by a customer (not shown) into the zone of a product group indicated by several products 5₁ to 5₃. The products 5₁ to 5₃ are accommodated on three shelves 6₁ to 6₃ indicated diagrammatically of a shelving unit 6. Indicated diagrammatically, for example, at the front edge of the shelves 6₁ to 6₃ in front of each product 5₁ to 5₃ are labelling means in the form of electronic shelf labels (ESLs) 4₁ to 4₃. The ESLs 4₁ to 4₃ are assigned emitter/detector units (not shown in FIG. 2) emitting at regular intervals the identification code of each ESL.

Alerting means 12′₁ to 12′₃ may be arranged at the front edge of the shelves 6₁ to 6₃ directly in front of or near to the various products 5₁ to 5₃. As an alternative, alerting means 12′₁ to 12′₃ may also be provided directly on or near to the ESLs 4₁ to 4₃ or also integrated in the ESLs 4₁ to 4₃.

As cited at the outset it is only in the entrance area 10 that so-called product-specific information is communicated via the communication beam 8, for example, in the form of a modulated infrared beam in advertising the products concerned. Each item of this product-specific information is assigned an identification code of the ESLs 4 provided at the products being advertised, preferably as the leading code.

As soon as the shopping cart 3, in the detector/emitter means 2 of which all product-specific information of the products advertised is stored, is pushed by a customer into the zone or vicinity of an ESL 4, for example, ESL 4₂, arranged directly in front of or near to the product 5₂ being advertised, the detector/emitter means 2 applied to the shopping cart 3 is triggered by the emitter/detector unit of the ESL 4₂, resulting in its identification code being communicated via the communication beam 7.

Due to the communicated identification code of the ESL 4₂ the product-specific information relative to the product 5₂ is selected in the detector/emitter means 2 of the shopping cart 3 and signalled to the customer by means of the information means assigned to the detector/emitter means 2, for example, by appearing on a display. Substantially simultaneously with the display of the product-specific information, which in this case advertises the product 5₂, an alerting means 12₂ or 12′₂, arranged at or in the ESL 4₂ or at or before the product 5₂ being advertised, for outputting a visual and/or audible alert is activated to alert the customer explicitly to the product 5₂ advertised.

The alerting means 12₂ or 12′₂ is activated, for example, directly by the emitter/detector unit of the ESL 4₂. As an alternative, the separately mounted alerting means 12′₂ may also be activated by the detector/emitter means 2 applied to the shopping cart 3 as indicated in FIG. 2 by the broken line arrow 7′.

1. A method of supplying customers of a self-service market with product-specific information, comprising only in the entrance area (10) of the self-service market at least one emitter means (1) supplied by a central data processing means (11) with data and information, detector/emitter means (2) applied to shopping carts (3) each including an information means, products having electronic shelf labels (ESL) (4) each including an emitter/detector unit for wireless communication of data between said means, wherein a plurality of items of product-specific information including identification codes of said ESLs (4) provided at the corresponding products are communicated by said at least one emitter means (1) in said entrance area (10) to said detector/emitter means (2) of said shopping cart (3) pushed by said customer and stored therein, and on said shopping cart (3) being pushed into the zone of said ESLs (4), whose identification code is assigned a stored product-specific information, said product-specific information from said emitter/detector unit of said corresponding ESL (4) is activated in said corresponding detector/emitter means (2) of said shopping cart (3) pushed into said zone of said ESL (4) and informed to the customer by means of its information means.

2. The method as set forth in claim 1, characterized in that during display of a product-specific information by means of said information means of said customer shopping cart (3) an alerting means (12;12′) provided directly at or near to said corresponding product (5), or in the vicinity thereof, and outputting a visual and/or audible alert, is activated.

3. The method as set forth in claim 2, characterized in that said alerting means (12;12′) is triggered by said emitter/detector unit of said ESL (4) which activated said detector/emitter means (2) of said shopping cart (3) pushed into said zone of said ESL (4).

4. The method as set forth in claim 2, characterized in that each alerting means (12;12′) is triggered by said activated detector/emitter means (2) of said shopping cart (3).

5. The method as set forth in claim 2, characterized in that said ESL (4) provided on or near said advertised product (5) is caused to flash or light up by an activated alerting means (12;12′).

6. The method as set forth in claim 3, characterized in that said ESL (4) provided on or near said advertised product (5) is caused to flash or light up by an activated alerting means (12;12′).

7. The method as set forth in claim 1, characterized in that for customers of a self-service market having a customer service card with an individual customer profile pertinent to said self-service market, and after having been identified by their customer service card, only the product-specific information matching said individual customer profile is communicated by said at least one emitter means (1) in said entrance area (10) to said detector/emitter means (2) of said shopping cart (3) and stored there.

8. The method as set forth in claim 6, characterized in that products purchased by such customers and registered at the cash desk of said self-service market are communicated to said central data processing means (11) and analyzed as regards said individual customer profile to establish any change in said customer profile for updating it.

9. The method as set forth in claim 1, characterized in that satisfactory display of a product-specific information by means of said information means of said customer shopping cart (3) is registered in said detector/emitter means (2) thereof and/or confirmed by said detector/emitter means (2) relative to said emitter/detector unit of said ESL (4) assigned to said corresponding product (5) and registered there.
